(19) United States
(12) Patent Application Publication
(10) Pub. No.: US 2002/0054274 A1
(43) Pub. Date: May 9, 2002

(54) DISTRIBUTIVE LIGHT SCHEME FOR A MULTIPLE PROJECTION DISPLAY MATRIX

(76) Inventor: BRADLEY A. BLOECHEL, BEAVERTON, OR (US)

Correspondence Address: SCHWEGMAN, LUNDBERG, WOESSNER & KLUTH, P.A., P.O. BOX 2938, MINNEAPOLIS, MN, 55402, US

(21) Appl. No.: 09/474,173

(22) Filed: Dec. 29, 1999

(51) Int. Cl. G03B 21/26

(52) U.S. Cl. 353/30

(57) ABSTRACT

A multi-projection system has been described which has light guides as replacements for individual projector bulbs. In one embodiment, the bulb replacements remove the complexity of alignment and light source matching from the end user, and provide a simple mechanism that the presenter could employ to completely restore the display. Moreover, the improved system automatically solves the problem with unbalanced characteristics of the light source that produces the image.

### FIELD OF THE INVENTION

The present invention relates generally to distributing projection light and in particular the present invention relates to light guides serving as a direct replacement for projection bulbs.

### BACKGROUND OF THE INVENTION

Audio/visual displays have become an increasingly important component of presentations and speeches for a variety of persons. Politicians, inventors, attorneys, teachers, students, job applicants, and business persons among many others are using multi-video and multi-projector display systems to enhance their audio/video presentations.

Multi-video-monitor display systems are widely used in performing arts and in marketing for video presentation. These systems rely on the adjustments integrated in each monitor to match colors, brightness, and the overall picture quality of the individual monitors making up the display. Additionally, multi-video-monitor display systems require high reliability picture tubes. The picture tubes are commonly rated in expected performance years. In contrast, a conventional overhead projection bulb, sometimes referred to as a light source, is typically rated for 200 hours.

Consequently, within a multi-projector display system overhead projection bulbs fail frequently and at different hours. Intermittent bulb-failure is a substantial impediment to the quality of the video image. The video image's quality is lessened, especially where the output from each projector is combined to produce a single complete seamless image. Consequently, the characteristics of all bulbs used to produce the image must be closely matched.

In other multi-projection systems each projector has a discrete projection bulb. All bulbs must be initially characterized and sorted into matched sets. This gives a first order correction to variations in color temperature and brightness. To achieve the best repeatable match, the entire set of bulbs must be replaced when one bulb fails. Replacing an entire set of bulbs reduces the likelihood the second order characteristic will occur, i.e., filament aging. Subtle variations of color tint and relative brightness are easily detected by the human eye. Mechanically, when a bulb is replaced some adjustment of the projector is required. The mechanical adjustment destroys the alignment with neighboring projectors and consumes time in attempting to correct the alignment. The result is significant degradation in the overall image quality presented and costly time consuming steps to re-align. Disruptions of this type are unacceptable in the presentation forum.

Some end-users operate slide projectors or overhead projectors in multiple projector presentations. Conventionally the presentations include still images synchronized with voice and music. In these systems the content is not shared across projectors and the boundaries between projectors form a shadow box display. Non-sharing of the projectors greatly reduces the complexity of these systems. Color matching, relative brightness and alignment between projectors are reduced to below first order considerations. The necessity that all projector bulbs are working is equally less important for all but a few cases since the other projectors deliver complete images.

For the reasons stated above, and for other reasons stated below which will become apparent to those skilled in the art upon reading and understanding the present specification, there is a need in the art for improving and easing an end user's ability to match the projectors' light sources and align them properly.

### SUMMARY OF THE INVENTION

The above mentioned problems and other problems are addressed by the present invention and will be understood by reading and studying the following specification.

In one embodiment, a distributive light source system comprises a light source, and an optical splitter operatively coupled to the light source. Within the optical splitter's transmission pathway is at least one light guide that is capable of receiving light and transmitting light distributively while retaining identical first and second order light characteristics throughout several transmission pathways.

A method of matching light wave characteristics is provided in one embodiment. The light wave characteristics have a first and a second order for a multi-media video device. The method comprises providing several light wave transmission pathways from a light source using a plurality of light guides. Subsequently, a plurality of multi-media projectors receive the light wave transmission pathways. Whereupon, a seamless video image, having matching light wave characteristics of the first and second order, is displayed by using a combined light output provided by the plurality of multi-media projectors.

In another embodiment, a multi-projector system comprises a light source, an optical splitter operatively coupled to the light source, and at least one light guide. The optical splitter provides a transmission pathway. The light guide is capable of receiving light from the transmission pathway and distributively transmitting the light. The transmitted light retains identical first and second order light characteristics throughout the light guides and transmission pathways. A plurality of projectors are electronically coupled together such that an output image comprises a combined and seamless image provided by the plurality of projectors receiving the identical light characteristics of the first and second order from at least one light guide.

### BRIEF DESCRIPTION OF THE DRAWINGS

FIG. 1 is a block diagram of one embodiment of a multi-projector system;

FIG. 2 is a diagram of a light source and optical splitter according to one embodiment of the invention; and

FIG. 3 is a flow chart diagram of a method embodiment of the present invention.

### DETAILED DESCRIPTION OF THE INVENTION

In the following detailed description of the preferred embodiments, reference is made to the accompanying drawings which form a part hereof, and in which is shown by way of illustration specific preferred embodiments in which the inventions may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense, and the scope of the present invention is defined only by the claims.

As stated above, multi-projection display systems are temperamental to unmatched projector bulbs within the display matrix system. One embodiment of the system includes a single remote light source, an optical splitter designed to supply an equal portion of light to each projector in a display matrix and n number of projectors. The remote light source is connected to each projector through at least one light guide per projector. Each projector is modified so that the light guide serves as a direct replacement for the projection bulb.

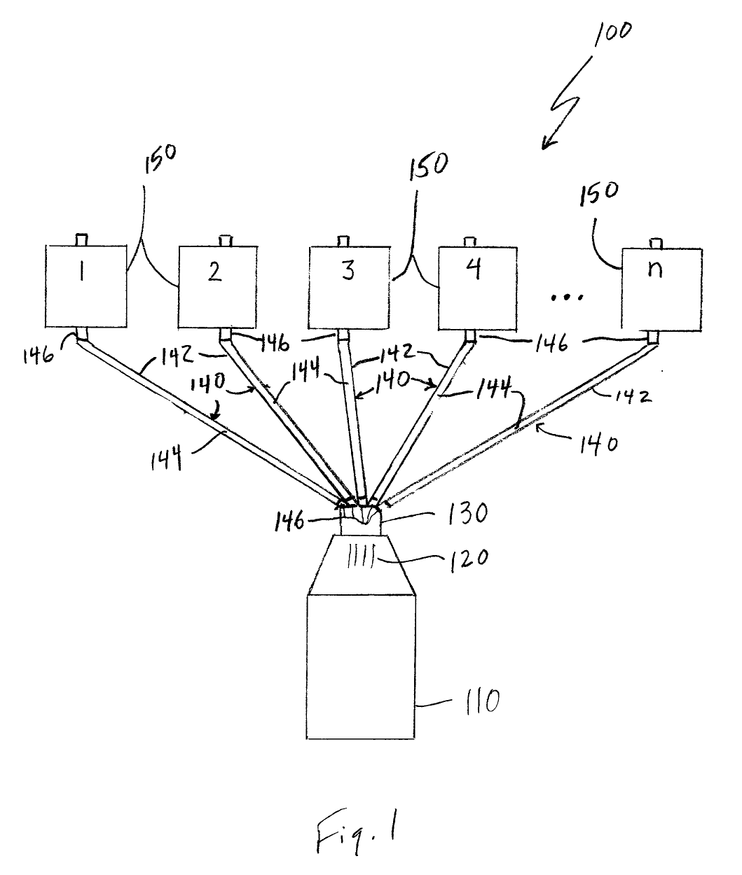

FIG. 1 illustrates one embodiment of a multi-projection system 100 using a single light source 110 and distributing light 120 from the light source 110 equally between all projectors 150. The multi-projection system 100 includes an optical splitter 130, and a plurality of flexible light guides 140. The flexible light guides decouple the light source 110 from each projector 150. Adjusting the light source 110 within reasonable limits needed to change the light source's bulb has no effect on the alignment of the individual projectors 150.

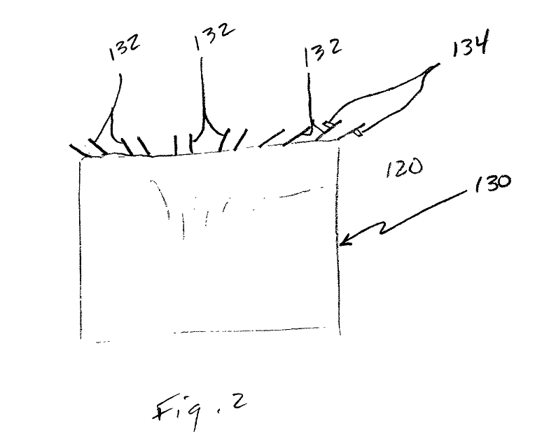

In one embodiment shown in FIG. 2, the optical splitter 130 includes a plurality of ports 132 for transmission of light 120 in multiple directions. The ports may include optical glass lenses of various size, shape, thickness, and quality. In one embodiment, the optical splitter has connections 134 for mechanically coupling light guides to its frame. Such mechanical connections may be any of a number of suitable connections including by way of example but not by way of limitation screws, clasps, thumb screws, snaps, collars, and the like.

In another embodiment, each light guide 140 includes a substantially tubular frame 142 enclosing transmission material 144 and having optical glass lenses 146 on both ends. In one embodiment, the transmission material can include a liquid substance. In another embodiment, the frame of the light guide can include other shapes and have multiple dimensions.

Another embodiment of the invention includes a light guide that solely transmits illumination. The transmission of illumination may be a function of the uniformity within the transmission material.

In another embodiment, the light source may be a projector's bulb. Methods of switching projection bulbs to a ready spare when the primary source has failed are simple and quick and widely used. Such a bulb switch can be done without interrupting the presentation. All characteristic differences associated with the new bulb are automatically applied to all projectors equally through the light guides so the entire distributed image remains balanced. In another embodiment, a light source may remotely exist outside the multi-projection system.

A light source that provides a full light spectrum from a gaseous mixture is used in another embodiment of the invention. For example, the gaseous material can include xenon. In such an embodiment, the light source includes an elaborate reflector and has a high intensity rating.

Modifying the individual projectors within a display matrix to receive a light guide provides another embodiment of the invention. In such an embodiment, the output visual image is controlled within the projectors.

Distribution of light 120 can be implemented in several ways. In one embodiment, a distributive light source system comprises a light source, an optical splitter operatively coupled to the light source, and at least one light guide within the optical splitter's transmission pathway. The light guide can be capable of receiving light and transmitting light distributively while retaining identical first and second order light characteristics throughout transmission pathways. The light guide may be constructed for selective flexibility.

The above distributive light source system provides a multi-video display wall comprising a plurality of projectors. As such, the multi-video display wall is optically coupled to one or more light guides. In another embodiment, the multi-video display wall further comprises a plurality of overhead projectors.

One embodiment of the invention includes ranking characteristics that define the quality of a light source. In one such embodiment, there exists two or more characteristic orders that may be used to rank the light source. For example, within one embodiment of the above described distributive light system the first order light characteristic comprises color temperature and brightness. A second order light characteristic comprises filament aging and transmitted light alignment.

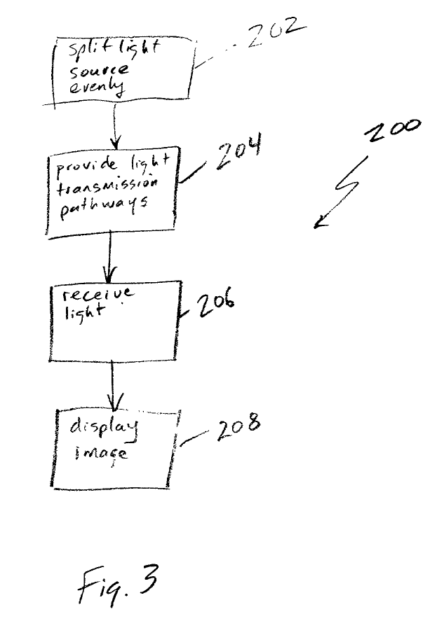

The above described distributive light source system includes in another embodiment shown in FIG. 3 a method 200 to match light wave characteristics having a first and a second order for a multi-media video device. The method comprises splitting a light source 202, and providing several light wave transmission pathways from the light source using a plurality of light guides 204. A plurality of multi-media projectors receive the transmitted light from the light wave transmission pathways 206 before displaying a seamless video image 208. The seamless video image in one embodiment has have matching light wave characteristics of the first and second order. The image is provided using a combined light output from the plurality of multi-media projectors. While multi-media devices are discussed, other video devices may be used without departing from the scope of the invention.

In one embodiment of the method the plurality of multi-media projectors receive the transmitted light wave provided by adjusting the light guide.

In a separate embodiment, the method provides a seamless video image by directing a light source toward an optical splitter. The optical splitter is operatively coupled at a first end to the light source. At a second end of the optical splitter a plurality of flexible light guides are optically coupled. Simultaneously or at different moments in time, the light guides direct the light to a matrix of video projectors. Hence, combining an equally matched output of light from the matrix of video projectors forms a single complete seamless image.

Another embodiment of the invention includes a multi-projector system comprising a light source, an optical splitter operatively coupled to the light source, and at least one light guide within the optical splitter's transmission pathway. The light guide is capable of receiving light and transmitting light distributively. Simultaneously, the light guide can retain identical first and second order light characteristics throughout the transmission pathways. In one embodiment, a light guide is used for each projector.

In another embodiment, a plurality of projectors are electronically coupled together such that an output image comprises a combined and seamless image. The plurality of projectors may receive identical light characteristics of the first and second order from at least one light guide.

The invention in another embodiment includes projectors for presentation graphics and video graphics, for example, projectors manufactured by In Focus Systems. Projectors of this sort include a small LCD between the lens and the light source. Also, included are micro-machined mirrors. A chip may house an array of miniature mirrors, produced for example by Texas Instrument. Such projectors are widely-used, for example within a multi-media environment.

### CONCLUSION

A multi-projection system has been described which has light guides as replacements for individual projector bulbs. In one embodiment, the light guides enable one to remove the complexity of alignment and light source matching from the end user, and provide a simple mechanism that the end-user could employ to completely restore the display. Moreover, the improved system automatically solves the problem with unbalanced characteristics of the light source that produce the image.

Although specific embodiments have been illustrated and described herein, it will be appreciated by those of ordinary skill in the art that any arrangement which is calculated to achieve the same purpose may be substituted for the specific embodiment shown. This application is intended to cover any adaptations or variations of the present invention. Therefore, it is manifestly intended that this invention be limited only by the claims and the equivalents thereof.

What is claimed is:

1. A distributive light source system comprising:
a light source;
an optical splitter operatively coupled to the light source;
at least one light guide within the optical splitter's transmission pathway and capable of receiving light and transmitting light distributively while retaining identical first and second order light characteristics throughout transmission pathways.

2. The distributive light source system of claim 1 wherein the light source includes a gaseous mixture providing transmission of a full light spectrum.

3. The distributive light source system of claim 1 wherein the light guide is flexibly constructed.

4. The distributive light source system according to claim 3 wherein the light guide comprises transmission material and is optically coupled to a multi-video display wall.

5. The distributive light source system of claim 4 wherein the multi-video display wall comprises a plurality of projectors.

6. The distributive light source system of claim 5 wherein the multi-video display wall further comprises a plurality of overhead projectors.

7. The distributive light source system of claim 1 wherein the first order light characteristic comprises color temperature and brightness.

8. The distributive light source system of claim 1 wherein the second order light characteristic comprises filament aging and transmitted light alignment.

9. A method to match light wave characteristics having a first and a second order for a video device comprising:
providing several light wave transmission pathways from a light source using a plurality of light guides;
receiving the light wave transmission pathways at a plurality of projectors; and
displaying a seamless video image having matching light wave characteristics of the first and second order using a combined light output provided by the plurality of multi-media projectors.

10. The method according to claim 9 further comprising:
receiving the transmitted light wave provided by adjustment of the light guide at the plurality of projectors.

11. The method of claim 10 wherein the light guide is flexibly constructed.

12. The method of claim 9 wherein the light wave transmission pathways are provided using an optical splitter.

13. The method of claim 9 wherein the first order characteristics comprises a color temperature characteristic and a brightness characteristic.

14. The method of claim 9 wherein the second order characteristics comprises an alignment characteristic.

15. A method of providing a seamless video image, the method comprising:
directing a light source towards an optical splitter, the optical splitter is operatively coupled at a first end to the light source, and at a second end the optical splitter is optically coupled to a plurality of flexible light guides, the light guides direct the light to a matrix of video projectors; and
combining an equally matched output of light from the matrix of video projectors to form a single complete seamless image.

16. The method of claim 15 wherein the flexible light guides have a liquid inner structure.

17. A multi-projector system comprising:
a light source;
an optical splitter operatively coupled to the light source;
at least one light guide within the optical splitter's transmission pathway and capable of receiving light and transmitting light distributively while retaining identical first and second order light characteristics throughout transmission pathways; and
a plurality of projectors electronically coupled together such that an output image comprises a combined and seamless image provided by the plurality of projectors receiving the identical light characteristics of the first and second order from at least one light guide.

18. The multi-projector system of claim 17 wherein the light source includes a gaseous mixture providing transmission of a full light spectrum.

19. The multi-projector system of claim 17 wherein construction of the light guide provides flexible adjustment.

20. The multi-projector system of claim 17 wherein the first order light characteristic comprises color temperature and brightness.

21. The multi-projector system of claim 17 wherein the second order light characteristic comprises filament aging and projector alignment.

22. A method, comprising:
splitting light from a light source evenly into a plurality of light guides;
transmitting light through the light guides to a plurality of projectors; and
combining output of the plurality of projectors into a seamless video image.

23. The method of claim 22, wherein the light is split with an optical splitter.

24. The method of claim 22, and further comprising:
aligning the plurality of light guides and projectors to an aligned configuration.

25. The method of claim 24, and further comprising:
replacing the light source without affecting the alignment.
